(19) United States
(12) Patent Application Publication
(10) Pub. No.: US 2026/0020556 A1
(43) Pub. Date: Jan. 22, 2026

(54) USER OPERATED ELECTRIC WEEDING SYSTEM AND METHOD FOR ACTIVATING A USER OPERATED ELECTRIC WEEDING SYSTEM

(71) Applicants: Zasso Group AG, Zug (CH); Zasso Brasil Indústria e Comércio de Máquinas Ltda., Indaiatuba, SP (BR)

(72) Inventors: Sergio de Andrade COUTINHO FILHO, Indaiatuba, SP (BR); George Maurice Alfred THOMPSON, Aachen (DE)

(73) Assignees: Zasso Group AG, Zug (CH); Zasso Brasil Indústria e Comércio de Máquinas Ltda., Indaiatuba, SP (BR)

(21) Appl. No.: 18/995,949

(22) PCT Filed: Sep. 15, 2022
(86) PCT No.: PCT/BR2022/050367

§ 371 Date: Jan. 17, 2025

(51) Int. Cl. A01M 21/04; G05B 9/02

(52) U.S. Cl. CPC A01M 21/046; G05B 9/02

(57) ABSTRACT

The present invention provides a user operated electric weeding system comprising: a user operated applicator comprising at least one electrode for applying electric energy into a plant; a source of electrical energy having a terminal electrically connected to the electrode and other terminal electrically connected to a ground electrode; and a control system for controlling the operation of the user operated applicator. The system further comprises insulating boots comprising at least one sensor for detecting the presence of the user inside the insulating boots, wherein the sensor is configured to communicate with the control system, wherein the control system is configured to prevent the activation of the applicator if the presence of the user is not detected.

### FIELD OF THE DISCLOSURE

The present invention relates to a user operated electric weeding system comprising a safety system for preventing accidents during high voltage operations. More specifically, the present invention refers to a user operated electric weeding system comprising boots with a user presence sensor and a control system configured to prevent the activation of the system in case the user is not wearing the protective equipment.

### DESCRIPTION OF RELATED ART

Electric weeding systems for destroying unwanted plants by electrocution have been used to control weeds or other harmful plants. These weeding devices based on the application of high voltage electrical energy were proposed as an alternative to other forms of weed control such as portable equipment for herbicide application.

The state of the art comprises several user operated weeding equipment operate by means of the application of high voltage.

Document WO1999025186A1 relates to a device for electric weeding of plants, such as adventive plants, in cultivated lands, comprising an electric power source whereof one terminal is electrically connected to earth by a ground electrode and the other is connected to at least one active electrode for destroying plants by sending on them an electric discharge. The active electrode is mounted at the end of the control member for bringing said electrode selectively towards a plant identified for destruction. WO1999025186A1 discloses an embodiment with a separate ground electrode that must be fixed into the soil and one embodiment wherein the ground electrode is built in the applicator. The electric power source, supported on the user's back for improving the freedom during operation, is capable of generating an electric arc when the electrode comes in the proximity of the plant to be destroyed or in contact with it.

Document WO2018229198A1 relates to embodiments of device for controlling unwanted ground vegetation with an electric voltage supply for providing a supply voltage in the extra-low or low voltage range, an electric boost converter for providing a high voltage from the supply voltage, and at least one applicator for transferring high voltage pulses to the unwanted ground vegetation. According to WO2018229198A1, a capacitive electric storage element for the high voltage is arranged in the electric path to the applicator, and a pulse former is arranged in the electric path between the storage element and at least one application electrode of the applicator.

Considering that the electric weeding is performed with the use of high voltages, there is a risk that the user may suffer an accident due to the high energy on the soil and dielectric boots must be used as protective equipment. Nevertheless, the user may incorrectly try to activate the device without such protective equipment. Still, the equipment could be mistakenly activated when the user is not wearing the insulating boots. These situations could lead to a serious accident to the user.

Therefore, the prior art lacks a solution that provides a user operated weeding equipment or a method for operating a weeding device comprising a safety feature for preventing accidents due to the exposure of high electrical energy.

### SUMMARY OF THE INVENTION

The present invention provides a user operated electric weeding system comprising: a user operated applicator comprising an electrode for applying electrical energy into a plant, wherein the applicator comprises at last one switch for activating the system when triggered by the user; a source of electrical energy having a terminal electrically connected to the electrode and other terminal electrically connected to a ground electrode; and a control system for controlling the operation of the user operated applicator. The system further comprises a pair of insulating boots, wherein at least one of the insulating boots comprises at least one sensor for detecting the presence of a user's foot inside the insulating boot, wherein the sensor is configured to communicate with the control system, wherein the control system is configured to prevent the activation of the applicator if the presence of the user is not detected.

The present invention also refers to a method for activating a user operated electric weeding system comprising checking if the at least one switch of the applicator was triggered by the user; checking, via a sensor provided in at least one insulating boot, if a user's foot is inside the insulating boot; provided that the user's foot is inside the insulating boot, activating the user operated electric weeding system by the control system; otherwise, preventing the activation of the applicator (10) if the presence of the user's foot is not detected.

### BRIEF DESCRIPTION OF THE DRAWINGS

The invention is explained in greater detail below and makes references to the drawings and figures, attached herewith, when necessary. Attached herewith are:

FIG. 1 shows an exemplificative user operated electric weeding system according to the present invention according to an embodiment of the present invention.

FIG. 2 shows a pair of dielectric boots according to an embodiment of the present invention.

FIG. 3 shows an exemplificative user operated electric weeding system according to the present invention according to a second embodiment of the present invention.

FIG. 4 shows a flowchart of a method for controlling a user operated electric weeding system according to an embodiment of the present invention.

### DETAILED DESCRIPTION OF THE INVENTION

The following description is based on preferred embodiments of the invention applied to a user operated electric weeding system. However, the present invention is not limited to a particular embodiment, as it will be clear for a skilled person.

FIG. 1 shows an illustrative embodiment of a user operated electric weeding system according to the present invention. Generally, the present invention relates to a user operated electric weeding system comprising a user operated applicator 10 comprising an electrode 11a for applying electrical energy into a plant 1, the applicator comprises at last one switch for activating the system when triggered by the user. In addition, the applicator 10 is connected to an electrical power source and a control system configured to control the operation of the user operated applicator 10. The system also comprises a pair of insulating boots 30, wherein at least one of the insulating boots 30 comprises at least one sensor configured to detect the presence of a user's foot inside the insulating boot and communicate to the control system. The control system is configured to prevent the activation of the applicator if the presence of the user is not detected.

In this preferred embodiment, the user operated electric weeding system is a handheld applicator device supplied and controlled by a battery and a control box, respectively, located on the back of the user in a backpack structure 20. This preferred embodiment improves the freedom of the user during operation. The backpack structure 20 has a fixed chassis where the battery and the control box housing the components for controlling the activation of the system are located. The battery is removable and allows multiple batteries to be used one after another. For supporting the battery, a battery holder is provided in the backpack structure 20 comprising a mechanical connection, strong enough to hold the weight of a 5 kg battery. This mechanical connection also allows for the fast exchange of batteries, which enables the user to work continuously with the exchange of batteries.

The control system is made of a custom printed circuit board (PCB) which monitors inputs of the system and use controls to activate the system.

Optionally, the control system comprises a safety relay that implements the safety functions of the system. For example, in the event of a hazard, the safety relay will work to reduce risk to an acceptable level. When an error occurs, the safety relay will initiate a safe and reliable response.

In addition, the backpack structure 20 houses the power module components formed by a high frequency voltage transformer, consisting of key subassemblies. This system takes the energy stored on the DC Battery and converts it into high frequency AC voltage capable of destroying plants. It functions at a frequency which plants are particularly sensitive to.

Moreover, the system comprises power and control cables for connecting the backpack structure 20 to the applicator 10. Preferably, there is an interface between the applicator 10 and the backpack structure 20 allowing the quick connection of these equipment. This interface can be in the form of two multi-pin plugs for power (High frequency AC) and control (low voltage signal lines). These cables being directly connected to the backpack 20.

The applicator 10 is a stick that is held by the user in front of him and holds the high-voltage components (transformer and multiplier) on different casings 13 along its length. The user has full freedom to use the system wherever they travel by foot. The two subsystems (applicator 10 and backpack structure 20) are connected via an over the shoulder cable with a quick-release plug.

The applicator 10 preferably comprises two electrodes 11a and 11b which are adjustable in position using a rotary arm 12. This rotary arm is spring loaded to support the weight of the applicator whilst maintaining a constant ground contact for a good electrical connection. As the user pushes the electrode 11b into the ground, they can adjust the distance between the electrodes 11a and 11b and decrease the height of the plant 1 touching electrode 11a. This preferred embodiment improves the mobility of the user operated equipment since it allows the user to fully adjust the weeding operation for different plants in a simple manner. However, the applicator may comprise a single active electrode and a separate ground electrode may be fixed into the soil as seen, for example, in embodiments of documents WO1999025186A1 and WO2018229198A1.

Considering the risks of operation of electric weeding due to the high voltage, the user should use protective equipment such as dielectric boots for isolation. However, in some cases the user may activate the applicator when not wearing the protective equipment or being mistakenly turned on. In order to prevent accidents in operation, the present invention proposes a system comprising insulating boots that are configured for detecting the presence of the use in order to allow the activation of the applicator.

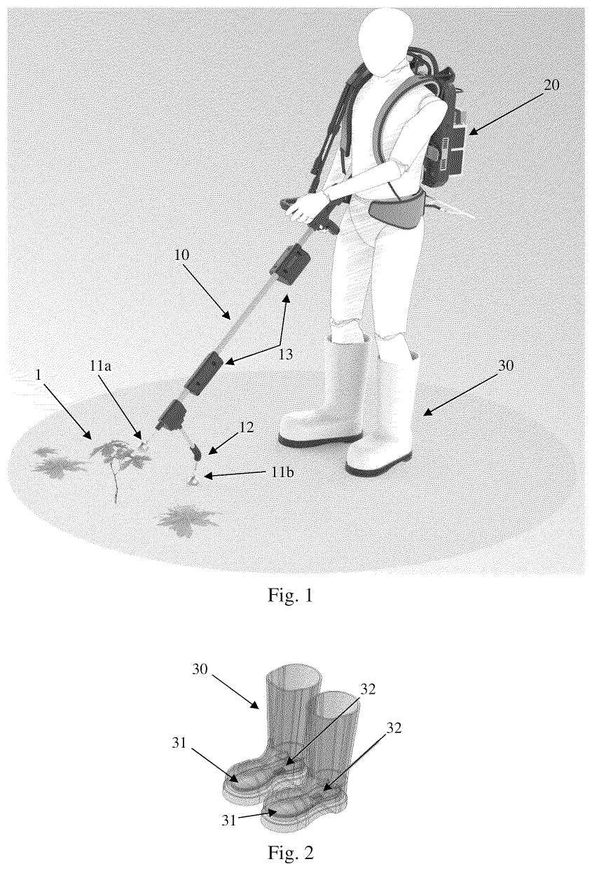

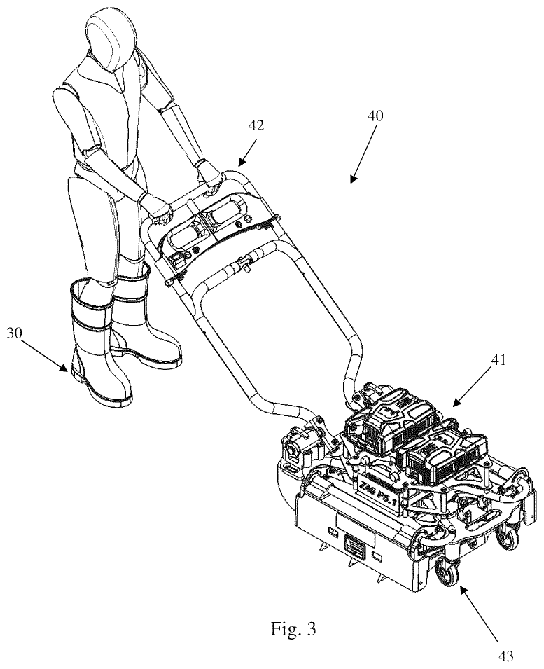

FIG. 2 shows a pair of insulating boots 30 according to the present invention in detail. The insulating boots 30 are fully integrated dielectric boots for providing protection for voltages up to 20 kV. Each boot 30 comprises a sensor 32 for detecting the presence of the user and is connected via wireless connection to the control system which is preferably housed in the backpack structure. Preferably, the sensor 32 is positioned in the insoles 31 of the boots 30. For the proper functioning of the system, the sensor 32 detects when the user wears the boots 30. In addition, the control system is configured to prevent the activation of the applicator 10 if the presence of the user is not detected. Thus, upon receiving the information that the user is wearing the insulating boots 30, the control system allows the activation of the applicator 10. Otherwise, even if the user tries to trigger the activation of the applicator 10, the control system will prevent this operation in order to ensure the safety of the user.

In a preferred embodiment, the sensor 32 is a pressure sensor driven by a force sensitive resistor (FSR). The sensor 32 may be formed by a combination of films and foams which give a different resistance and voltage output when compressed (such as when the user wears the boots). The voltage difference can be amplified (via an operational amplifier) and then sensed by a circuit on the connection module. The circuit can determine if the user is inside the safety boots based on the voltage input. The sensor 32 then communicates to the control system providing a binary signal to the control system (“on” or “off”) which is used as a safety input before the system generates high voltage. Alternatively, other parameters may be monitored by the sensor 32 to detect the presence of the user such as a heart monitoring sensor, a temperature reading capacitive or a body current reading sensor.

Preferably, the sensors 32 comprises a Bluetooth low energy transceiver printed circuit board (PCB) for the wireless connection. Naturally, other modules can be used for the connection of the sensor 32 such as a radiofrequency identification (RFID) or near field communication (NFC).

In a further alternative embodiment of the invention, the user operated electric weeding system comprises an accelerometer (not shown) to identify when the applicator is raised over the ground, and the control system is configured to prevent the activation of the applicator 10 when the accelerometer detects an elevation of the applicator. Such configuration provides an additional safety measure, since, when the applicator is raised above the ground, its electrodes 11a, 11b are exposed to accidentally contact the user or other people or animals close to the applicator 10.

From the description above, it will be clear that the present invention may be used in different embodiments of weeding devices.

FIG. 3 shows another exemplificative embodiment of the user operated applicator, which consists of a hand-pushed weeding device 40 comprising wheels 43 for moving over the area to be treated by the user. The hand-pushed weeding device 40 comprises a panel attached to the handles 42 comprising at least one switch for activating the system when triggered by the user while pushing the applicator over the area. The applicator comprises an electrode (not shown) positioned under the structure of the hand-pushed device for applying electrical energy into a plant.

The hand-pushed weeding device comprises a housing 41 for housing the power source and the control system on the structure of the hand-pushed weeding device 40. The source of electrical energy having a terminal electrically connected to the electrode and other terminal electrically connected to a ground electrode (not shown). The control system is configured for controlling the operation of the user operated applicator.

The user wears a pair of insulating boots 30 for protection during operation. As in the other embodiment, the control system is configured to communicate with the sensors of the insulating boots 30 for detecting the presence of a user's foot inside the insulating boot and communicate to the control system, which is further configured to prevent the activation of the applicator if the presence of the user is not detected as already described.

In view of the disclosure above the present invention also refers to a method for activating a user operated electric weeding system comprising:
checking if the at least one switch of the applicator was triggered by the user; checking, via a sensor provided in at least one insulating boot, if a user's foot is inside the insulating boot;
provided that the user's foot is inside the insulating boot, activating the user operated electric weeding system by the control system; otherwise, preventing the activation of the applicator (10) if the presence of the user's foot is not detected.

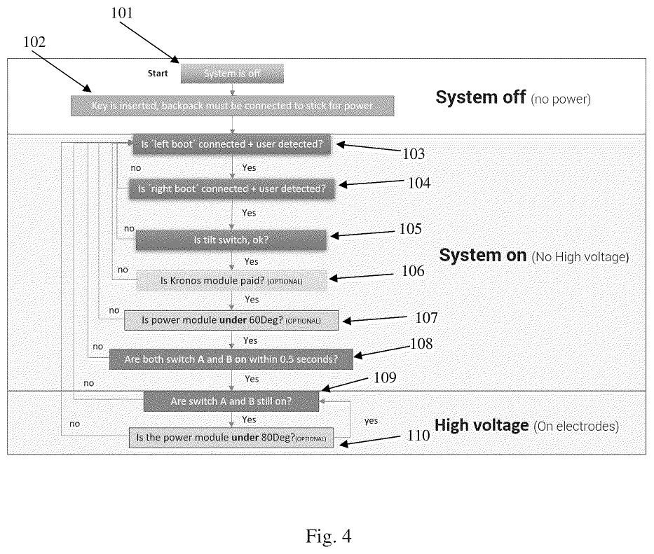

In other embodiments of the invention, the user safety may be improved by adding more safety conditions for allowing the generation of high voltage. FIG. 4 shows a flowchart representing the steps of an exemplificative embodiment of controlling and operating a user operated electric weeding equipment according to the present invention.

In this preferred embodiment, the applicator 10 further comprises a key switch that requires the use of a key to turn the system on and two manual switches activating the device. In addition, the applicator 10 also comprises a tilt sensor for monitoring the position of the applicator during operation. These features can provide three additional safety conditions.

The step 101 represents the start of the operation wherein the system is still turned off. Preferably, at step 102, the key is inserted in the key switch and switched to the “on” position. Accordingly, the system is on, but no high voltage is generated by the control system yet, since it requires that the user is wearing the insulating boots 30.

Accordingly, the second safety condition that should be met in this embodiment would be checking whether the user is wearing the protective equipment. To this end, at least one of the boots of the pair of insulating boots 30 may comprise one sensor 32 for detecting the presence of one of the user's feet. However, to further improve the safety during operation, preferably both insulating boots comprise one sensor 32 each since it would ensure that the protective equipment is properly used by the user.

Thus, at step 103 it is verified whether the left boot is connected. Similarly, at step 104 it is verified whether the right left boot is connected. As previously described, this verification is carried out with basis on the response of the sensor 32 that detects that presence of the user within each boot. According to the present invention, this verification is sufficient to indicate that the system can be activated, and the high voltage can be generated for electrocution.

At step 105 the system verifies whether the tilt-switch is in the correct position. Optionally, the system can check if the applicator is below a determined position. For example, in step 107 the power module must be tilted within an angle under 60 degrees in order to meet this condition and enable the activation.

Moreover, the system may check whether both hands of the user are connected to the isolated part of the applicator device. To that end, the applicator 10 may comprise two switches that are located on the isolated portion of the applicator. Therefore, at step 108 it is checked whether both switches were simultaneously triggered by the user or within a determined period. for example, the systema may check whether the switches were triggered within a period of 0.5 seconds with would enough to consider that they were pulled on the same time. This ensure that the user hands are in a safe position, as seen in FIG. 1 wherein both hands of the user are on the handles of the applicator.

Therefore, in case all safety conditions are met, the system may start to generate the high voltage.

Still, the system may also continuously check whether the device is positioned on a tilted position for weeding. At step 109, it is verified whether both switches are still triggered and at step 110 it verifies whether the applicator is in a correct position for weeding.

Therefore, the present invention solves the technical problem of providing a user operated electric weeding system that improves the safety of the users during operation and prevents the occurrence of accidents in case the device is mistakenly activated.

While various example embodiments have been described above, it should be understood that they have been presented by way of example, and not limitation. It will be apparent to persons skilled in the relevant art(s) that various changes in form and detail can be made therein.

1. User operated electric weeding system comprising:
a user operated applicator comprising an electrode for applying electrical energy into a plant, wherein the applicator comprises at last one switch for activating the system when triggered by the user;
a source of electrical energy having a terminal electrically connected to the electrode and other terminal electrically connected to a ground electrode; and
a control system for controlling the operation of the user operated applicator;
wherein further comprising:
a pair of insulating boots, wherein at least one of the insulating boots comprises at least one sensor for detecting the presence of a user's foot inside the insulating boot, wherein the sensor is configured to communicate with the control system,
wherein the control system is configured to prevent the activation of the applicator if the presence of the user's foot is not detected.

2. System according to claim 1, wherein the source is a battery.

3. System according to claim 2, wherein the applicator is a handheld user operated applicator and the system further comprises a backpack structure for supporting the battery and the control system on the back of the user.

4. System according to claim 2, wherein the applicator is a hand-pushed weeding device comprising wheels and a housing for housing the battery and the control system.

5. System according to claim 1, wherein the sensor is one among the group including: a pressure sensing sensor, a heart monitoring sensor, temperature reading capacitive or a body current reading sensor.

6. System according to claim 1, wherein the sensor is wirelessly connected to the control system via Bluetooth low energy transceiver, radiofrequency identification (RFID) module or Near Field Communication (NFC) module.

7. System according to claim 1, wherein the control system comprises a safety relay for executing the safety functions of the system by controlling the electrical energy.

8. System according to claim 2, further comprising a power module comprising a high frequency voltage transformer converts the voltage of the battery in high frequency AC voltage.

9. System according to claim 8, further comprising a transformer and a multiplier for converting the high frequency AC voltage and generating the high voltage for the applicator.

10. System according to claim 1, wherein the ground electrode is built in the applicator.

11. System according to claim 10, wherein the ground electrode is attached to a rotary arm for adjusting the distance between the electrode and the ground electrode, wherein the rotary arm is spring loaded to support the weight applicator whilst maintaining a constant contact with the ground.

12. System according to claim 1, wherein the insulating boots are dielectric boots for blocking high voltages up to 20 kV.

13. System according to claim 1, wherein the sensor is positioned on the insoles of the insulating boots.

14. System according to claim 1, wherein the applicator comprises a key switch for activating the system and the control system is configured to keep the system off in case the key switch is not in the “on” position.

15. System according to claim 1, wherein the switch is a manual switch and the applicator comprises a second manual switch for activating the system and the control system is configured to keep the system off in case both manual switches are not triggered.

16. System according to claim 1, wherein the applicator comprises a tilt sensor for monitoring the position of the applicator, and the control system is configured to keep the system off in case the applicator is not tilted below a predetermined angle.

17. System according to claim 1, further comprising an accelerometer to identify when the applicator is raised over the ground, and
wherein the control system is configured to prevent the activation of the applicator when the accelerometer detects an elevation of the applicator over the ground.

18. Method for activating a user operated electric weeding system as defined in claim 1, comprising:
checking if the at least one switch of the applicator was triggered by the user;
checking, via a sensor provided in at least one insulating boot, if a user's foot is inside the insulating boot;
provided that the user's foot is inside the insulating boot, activating the user operated electric weeding system; otherwise, preventing the activation of the applicator (10) if the presence of the user's foot is not detected.

19. Method according to claim 18, wherein the applicator comprises a key switch for activating the system and the method further comprising activating the system in case the key switch switched to the “on” position.

20. Method according to claim 18, wherein the applicator comprises two manual switches for activating the system and the method further comprising activating the system in case both manual switches are triggered by the user.

21. Method according to claim 19, wherein the applicator comprises a tilt sensor for monitoring the position of the applicator, and the method further comprises checking if the applicator is within a predetermined angle and preventing the activation of the system in case the applicator is not tilted below the predetermined angle.
